(19) United States
(12) Patent Application Publication
(10) Pub. No.: US 2011/0103060 A1
(43) Pub. Date: May 5, 2011

(54) ILLUMINATION APPARATUS

(75) Inventors: Cheng Wang, Hsinchu County (TW); Po-Kuei Chou, Hsinchu County (TW)

(73) Assignee: YOUNG GREEN ENERGY CO., HSINCHU COUNTY (TW)

(21) Appl. No.: 12/873,322

(22) Filed: Sep. 1, 2010

(30) Foreign Application Priority Data
Oct. 29, 2009 (CN) 200910207689.4

(51) Int. Cl. F21S 4/00; F21V 29/00

(52) U.S. Cl. 362/249.02; 362/373

(57) ABSTRACT

An illumination apparatus includes an outer housing, a heat dissipation base, a plurality of heat dissipation fins, and a light source. The outer housing has a bottom wall with an air inlet and an opening. The heat dissipation base is connected to the bottom wall. The heat dissipation fins are connected to the heat dissipation base and the heat dissipation fins are substantially parallel to each other. Each of the heat dissipation fins has a concave and the concaves of the heat dissipation fins cooperatively form a groove. The orthographic projection area overlaps the air inlet. The light source is connected to the heat dissipation base and exposed through the opening. The illumination apparatus has a good heat dissipation efficiency.

### CROSS-REFERENCE TO RELATED APPLICATION

This application claims the priority benefit of China application serial no. 200910207689.4, filed on Oct. 29, 2009. The entirety of the above-mentioned patent application is hereby incorporated by reference herein and made a part of this specification.

### BACKGROUND OF THE INVENTION

1. Field of the Invention

The invention relates to an illumination apparatus.

2. Description of Related Art

With the continuous improvements on luminance and illumination efficiency of light emitting diodes (LEDs), illumination apparatus have started using LED as a light source in recent years. However, during operation, the LED generates heat and the heat may be removed to maintain the LED to operate within a normal operating temperature range.

The LED has been used as a light source for street lights. Heat generated by this type of street light may be dissipated by a loop heat pipe, a fan in combination with a fin-type heat sink, a heat pipe in combination with a fin-type heat sink or a fin-type heat sink.

FIG. 1 illustrates a conventional fin-type heat sink to dissipate heat of a light source. Referring to FIG. 1, the fin-type heat sink 50 includes a heat dissipation base 52 and a plurality of heat dissipation fins 54 disposed on an upper side of the heat dissipation base 52. A light source 60 is disposed on a bottom side of the heat dissipation base 52 such that heat generated by the light source 60 may be taken away by an airflow in the direction D1. However, the airflow stagnancy may easily occur at a central area A1 of the heat dissipation fins 54 and therefore the heat of the heat dissipation fins 54 may not be effectively taken away, such that the temperature of the central area A1 may not be lowered thus resulting in a low heat dissipation efficiency.

Additionally, Taiwan Patent Nos. 200823408, 585294, M249435, M343121, and I251462 disclose a solution that utilizes heat dissipation fins to dissipate heat of a light emitting element or a heat generating element.

### SUMMARY OF THE INVENTION

Accordingly, the invention is directed to an illumination apparatus having a good heat dissipation efficiency.

The other objectives and advantages of the invention may be further understood from the technical features disclosed in the invention.

To achieve at least one aforementioned and other objectives, one embodiment of the invention provides an illumination apparatus including an outer housing, a heat dissipation base, a plurality of heat dissipation fins, and a light source. The outer housing has a bottom wall with an air inlet and an opening. The heat dissipation base is connected to the bottom wall. The heat dissipation fins are connected to the heat dissipation base and the heat dissipation fins are substantially parallel to each other. Each of the heat dissipation fins has a concave and the concaves of the heat dissipation fins cooperatively form a groove. Orthographic projections of the heat dissipation fins on the bottom wall and spaces between adjacent orthographic projections of the heat dissipation fins cooperatively define an orthographic projection area. The orthographic projection area has a first width greater than a second width of an orthographic projection of the heat dissipation base on the bottom wall. The orthographic projection area overlaps the air inlet. The light source is connected to the heat dissipation base and exposed through the opening.

In view of the foregoing, the embodiment of the invention has at least one of the following advantages. The groove formed by the heat dissipation fins provides a space for the air to flow, thereby preventing air stagnancy at a central area of the heat dissipation fins and hence enhancing the heat dissipation efficiency. Additionally, the width of each heat dissipation fin is greater than the width of the heat dissipation base. Therefore, each of heat dissipation fins extends outwardly from two sides of the heat dissipation base and is positioned opposite to the bottom wall, and the heat dissipation fins extend over and beyond the air inlets, thus facilitating the airflow entering via the air inlets sufficiently contacting each heat dissipation fin so as to further enhance the heat dissipation efficiency.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 illustrates a conventional fin-type heat sink used to dissipate heat of a light source.

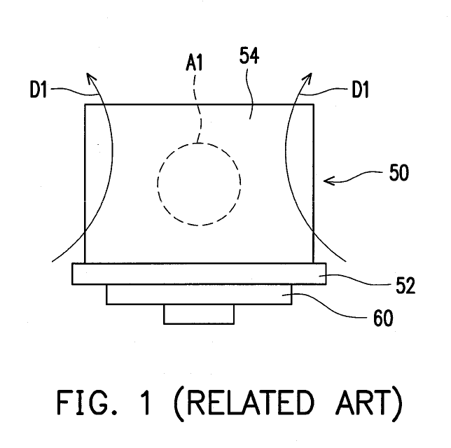

FIG. 2A is a partial top view of an illumination apparatus according to one embodiment of the invention.

FIG. 2B is a cross-sectional view of the illumination apparatus of FIG. 2A, taken along line A-A thereof.

FIG. 2C is a cross-sectional view of the illumination apparatus of FIG. 2A, taken along line B-B thereof.

FIG. 3 is a partial perspective view of the illumination apparatus of FIG. 2A.

FIG. 4 is a partial perspective view of the illumination apparatus of FIG. 2A.

FIG. 5 is a partial top view of the illumination apparatus of FIG. 2A.

FIG. 6 is a side view of some elements of an illumination apparatus according to another embodiment of the invention.

FIG. 7 is a partial perspective view of an illumination apparatus according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacently to” and variations thereof herein are used broadly and encompass directly and indirectly “adjacently to”. Therefore, the description of “A” component facing “B” component herein may contain the situations that “A” component directly faces “B” component or one or more additional components are between “A” component and “B” component. Also, the description of “A” component “adjacently to” “B” component herein may contain the situations that “A” component is directly “adjacently to” “B” component or one or more additional components are between “A” component and “B” component. Accordingly, the drawings and descriptions will be regarded as illustrative in nature and not as restrictive.

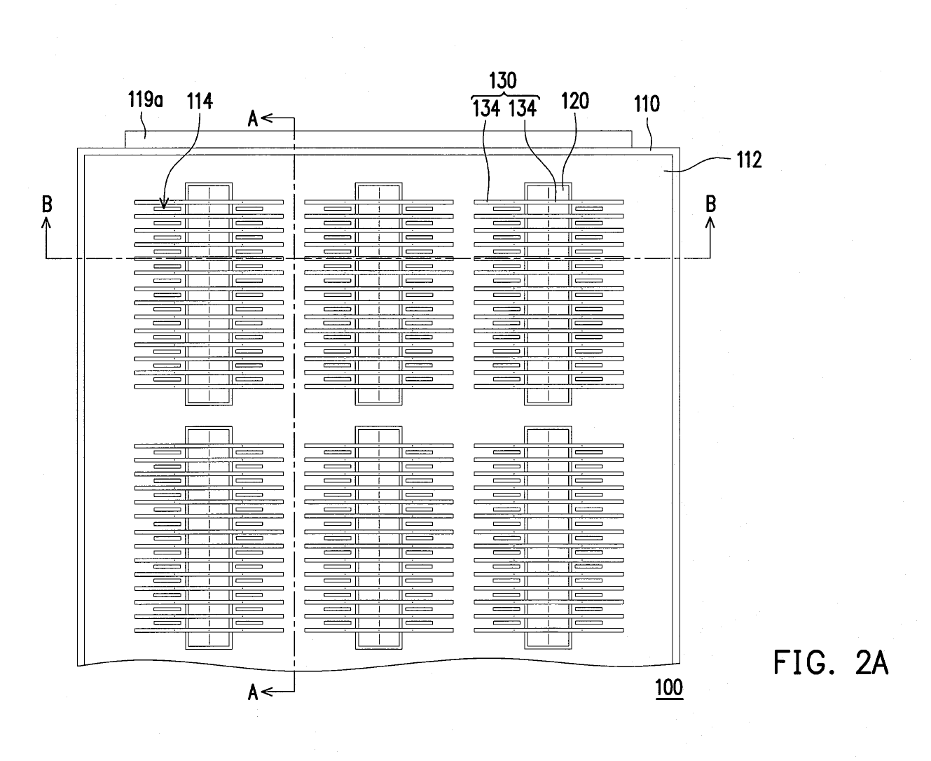

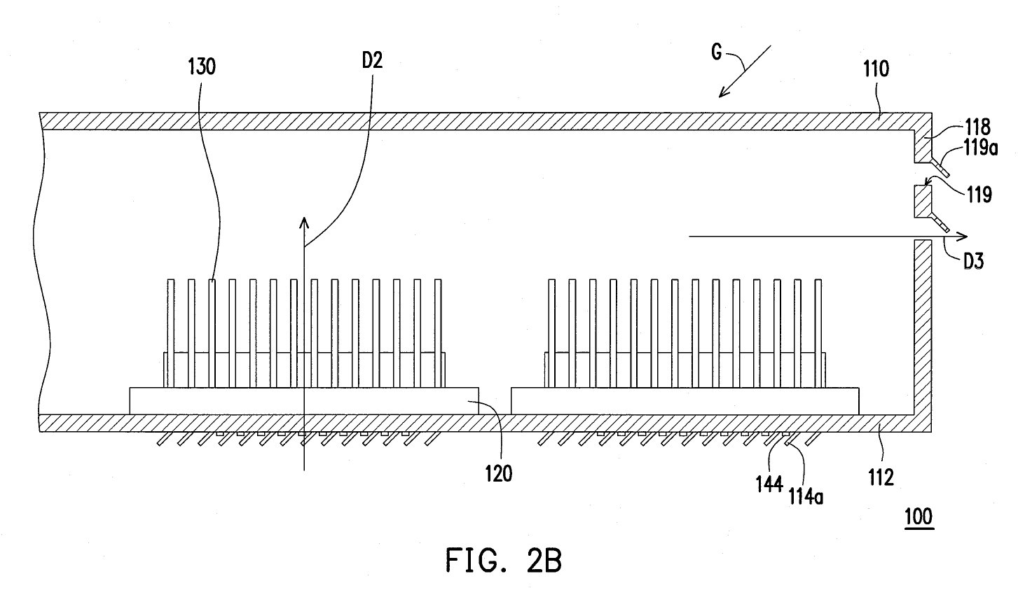

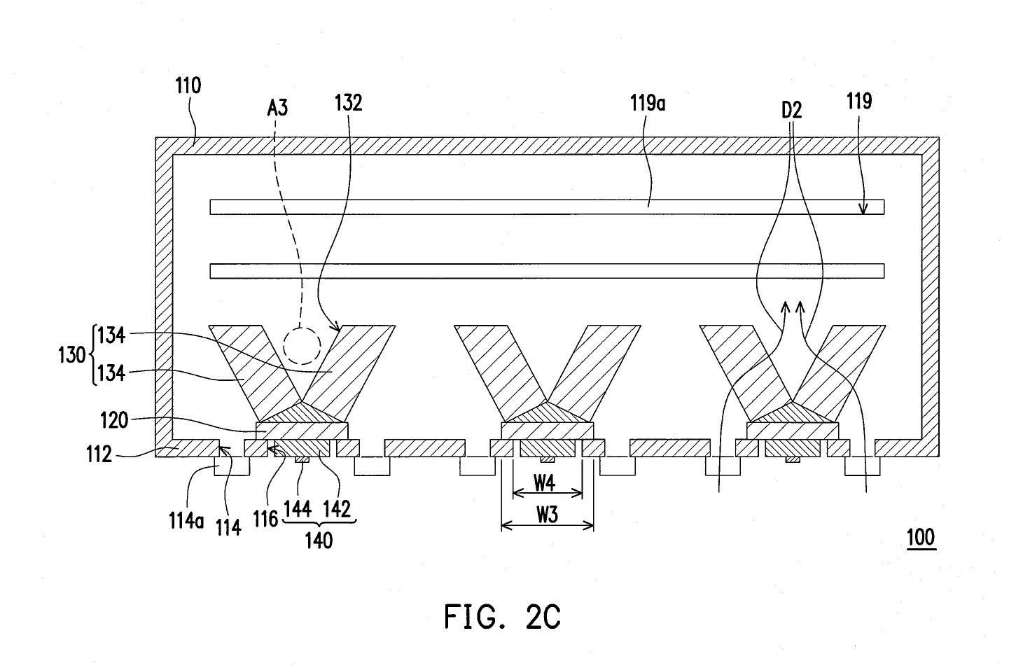

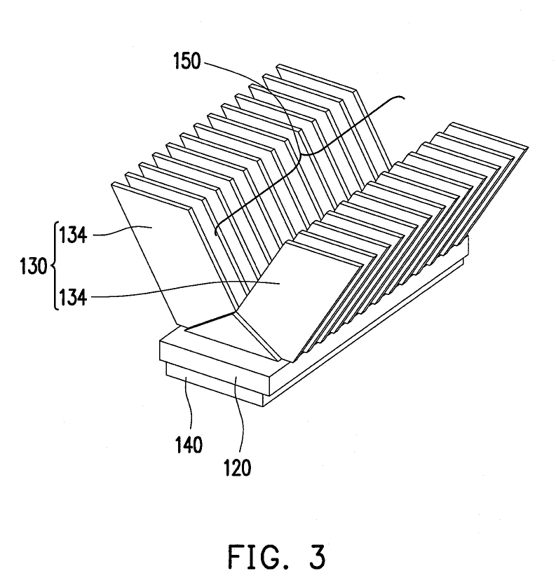

Referring to FIGS. 2A-2C and FIG. 3, the illumination apparatus 100 includes an outer housing 110, a plurality of heat dissipation base 120, a plurality of heat dissipation fins 130, and a plurality of light sources 140. The illumination apparatus 100 disclosed herein may be, for example, a street light.

The outer housing 110 includes a bottom wall 112 with a plurality of air inlets 114 and a plurality of openings 116. Air may enter the outer housing 110 through the air inlets 114. The openings 116 are used to expose the light sources 140 connected to the heat dissipation base 120, respectively.

The heat dissipation base 120 is connected to the bottom wall 112. The heat dissipation fins 130 are connected to the heat dissipation base 120 and are substantially parallel to each other. Each of the heat dissipation fins 130 has a concave 132 and all the concaves 132 of the heat dissipation fins 130 cooperatively form a groove 150.

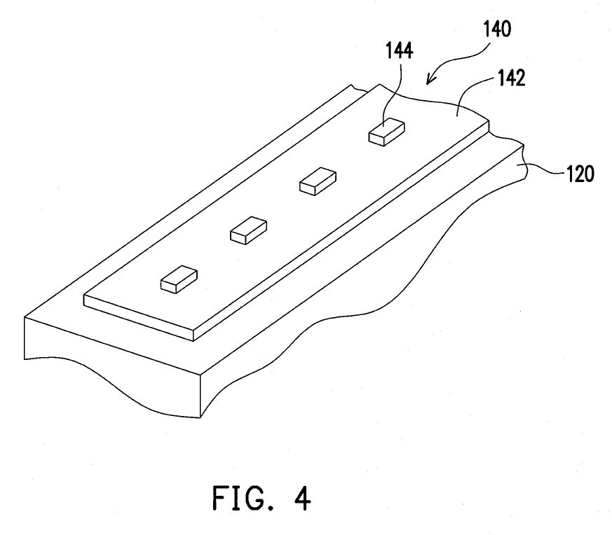

Referring also to FIG. 4, the light source 140 of the embodiment includes a carrier 142 and a plurality of light emitting diodes (LEDs) 144. The carrier 142 is disposed on the heat dissipation base 120 and the LEDs 144 are disposed on the carrier 142.

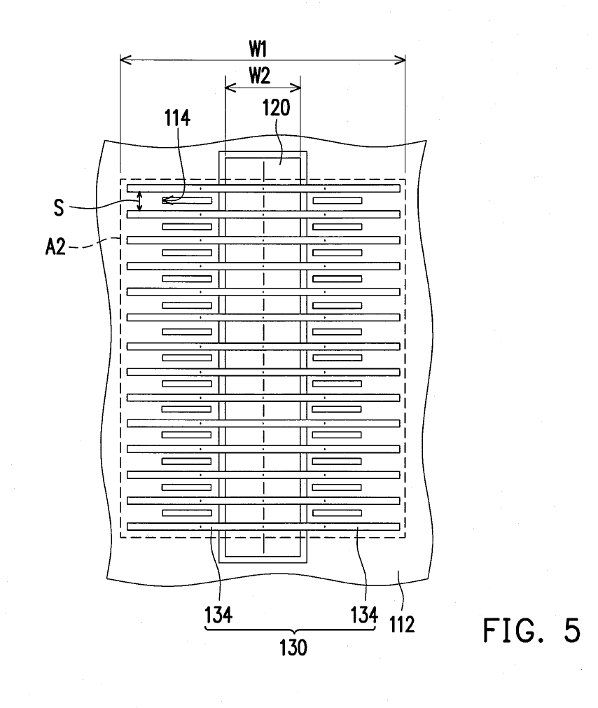

Referring to FIG. 5, orthographic projections of the heat dissipation fins 130 on the bottom wall 112 and spaces S between adjacent orthographic projections of the heat dissipation fins 130 cooperatively define an orthographic projection area A2 on the bottom wall 112. The orthographic projection area A2 has a width W1 greater than a width W2 of an orthographic projection of the heat dissipation base 120 on the bottom wall 112, and the orthographic projection area A2 overlaps the air inlets 114.

In other words, the width of each heat dissipation fin 130 is greater than the width of the heat dissipation base 120. Therefore, each of the heat dissipation fins 130 extends outwardly from two sides of the heat dissipation base 120 and is positioned opposite to the bottom wall 112. The heat dissipation fins 130 extend over and beyond the air inlets 114 such that the airflow entering the outer housing 110 via the air inlets 114 flows in the direction D2 shown in FIG. 2B and FIG. 2C to sufficiently contact each heat dissipation fin 130 for facilitating heat dissipation. In addition, the groove 150 (FIG. 3) formed by the heat dissipation fins 130 provides a space for the airflow to flow, thereby preventing air stagnancy at a central area A3 of the heat dissipation fins 130 and hence enhancing the heat dissipation efficiency.

In the embodiment, the ratio of the width W1 to the width W2 may be designed to be greater than 1.3 such that the air inlets 114 may be surely covered by the extension of the heat dissipation fins 130. In other embodiments not illustrated herein, the ratio of the width W1 to the width W2 may also be another suitable value greater than 1.

Referring to FIG. 2C, in the embodiment, each of the heat dissipation fins 130 includes two extending portions 134 cooperatively defining the concave 132. In the embodiment, an included angle formed between the extending portions 134 is, for example, 60 degrees. In other embodiments not illustrated herein, the included angle formed between the extending portions 134 may be another angle, for example, a suitable angle ranging from 10 to 80 degrees.

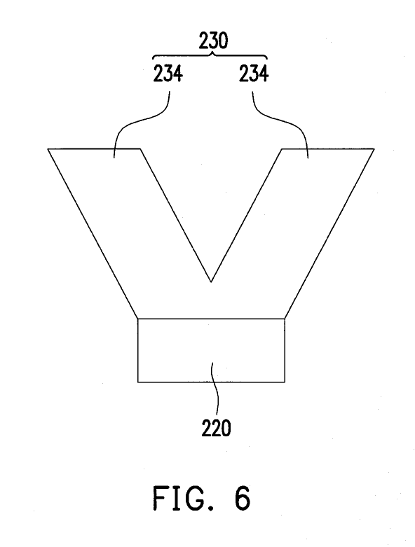

Referring to FIG. 6, different from the heat dissipation fin 130 of FIG. 2C formed by two separately formed extending portions 134, the heat dissipation fin 230 of FIG. 6 is formed with two integrally formed extending portions 234.

Referring to FIG. 2B, the outer housing 110 of the embodiment further includes a side wall 118 connected to the bottom wall 112 and a plurality of air outlets 119 disposed in the side wall 118. The airflow entering the outer housing 110 via the air inlets 114 first flows through the heat dissipation fins 130 to take the heat of the heat dissipation fins 130 away. The airflow then escapes the outer housing 110 via the outlets 119 to take the heat absorbed from the heat dissipation fins 130 away from the illumination apparatus 100.

It should be noted that a direction indicated by G in FIG. 2B represents, for example, the direction of gravity. In other words, the outer housing 110 is obliquely oriented such that the hot air may be successfully exhausted from the air outlets 119 along the direction D3 based on the principle that hot air rises. In addition, referring to FIGS. 2B and 2C, a shielding plate 114a may be disposed on an upper side of each air inlet 114 and a shielding plate 119a may be disposed on an upper side of each air outlet 119 to prevent rainwater, dusts or other objects entering the illumination apparatus 100 via the air inlets 114 and the air outlets 119.

Besides, in the embodiment, a width W3 of the heat dissipation base 120 is greater than a width W4 of the opening 116. Therefore, the heat dissipation base 120 may be supported by on the circumference of the opening 116 on the bottom wall 112, such that heat may be transferred to the bottom wall 112 for heat dissipation.

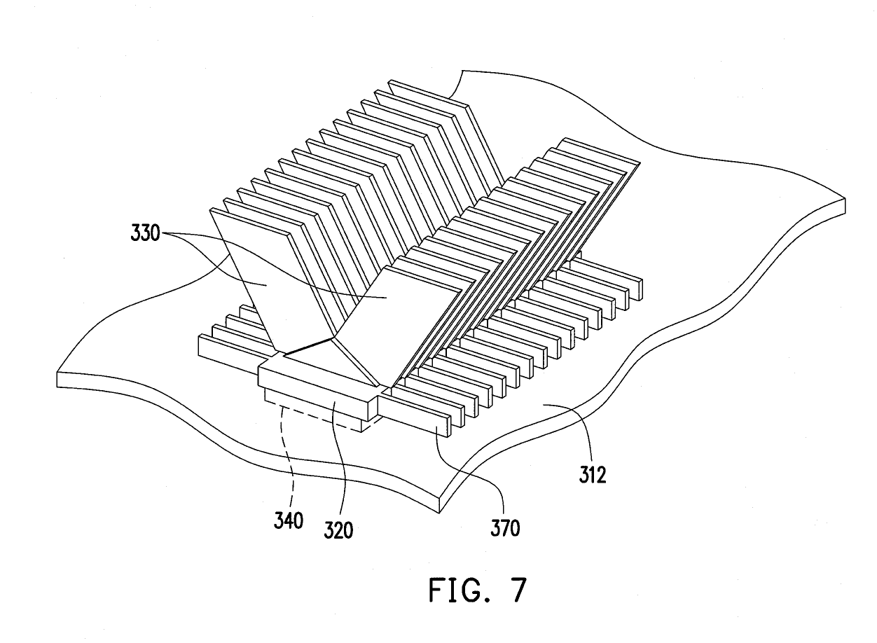

Referring to FIG. 7, in the present embodiment, a plurality of side fins 370 may further be disposed at two sides of the heat dissipation base 320 and the side fins 370 located between the heat dissipation fins 330 and the bottom wall 312. The function of the side fins 370 is similar to the function of the heat dissipation fins 330, i.e., absorption of the heat from the light sources 340. As such, the airflow entering via the air inlets (not shown) of the bottom wall 312 flows through the side fins 370 to take the heat of the side fins 370 away, and subsequently flows through the heat dissipation fins 330 to take the heat of the heat dissipation fins 330 away, thereby further enhancing the heat dissipation efficiency.

In summary, the embodiments of the invention have at least one of the following advantages. The groove formed by the heat dissipation fins provides a space for the airflow to flow, thereby preventing airflow stagnancy at the central area of the heat dissipation fins and hence enhancing the heat dissipation efficiency. In addition, the width of each heat dissipation fin is greater than the width of the heat dissipation base. Therefore, each of the heat dissipation fins extends outwardly from two sides of the heat dissipation base and is positioned opposite to the bottom wall, and the heat dissipation fins extend over and beyond the air inlets, thus facilitating the airflow entering via the air inlets sufficiently contacting each heat dissipation fin so as to further enhance the heat dissipation efficiency. Besides, a plurality of side fins may further be disposed on two sides of the heat dissipation base and the side fins located between the heat dissipation fins and the bottom wall. As such, the airflow may flow sequentially through the side fins and the heat dissipation fins to further enhance the heat dissipation efficiency.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination apparatus comprising:
an outer housing having a bottom wall with an air inlet and an opening;
a heat dissipation base connected to the bottom wall;
a plurality of heat dissipation fins connected to the heat dissipation base and being substantially parallel to each other, wherein each of the heat dissipation fins has a concave, the concaves of the heat dissipation fins cooperatively form a groove, orthographic projections of the heat dissipation fins on the bottom wall and spaces between adjacent orthographic projections of the heat dissipation fins cooperatively define an orthographic projection area, the orthographic projection area has a first width greater than a second width of an orthographic projection of the heat dissipation base on the bottom wall, and the orthographic projection area overlaps the air inlet; and
a light source connected to the heat dissipation base and exposed through the opening.

2. The illumination apparatus according to claim 1, wherein the ratio of the first width to the second width is greater than 1.3.

3. The illumination apparatus according to claim 1, wherein the outer housing comprises a side wall adjacent to the bottom wall, and the side wall defines an air outlet.

4. The illumination apparatus according to claim 3, wherein the outer housing comprises a shielding plate connected to an upper side of the air outlet.

5. The illumination apparatus according to claim 1, wherein the outer housing comprises a shielding plate connected to an upper side of the air inlet.

6. The illumination apparatus according to claim 1, further comprising a plurality of side fins connected to the heat dissipation base and disposed between the heat dissipation fins and the bottom wall.

7. The illumination apparatus according to claim 1, wherein each of the heat dissipation fins comprises two extending portions cooperatively defining the concave.

8. The illumination apparatus according to claim 7, wherein an included angle between the two extending portions is 10 to 80 degrees.

9. The illumination apparatus according to claim 7, wherein the included angle between the two extending portions is substantially 60 degrees.

10. The illumination apparatus according to claim 7, wherein the two extending portions are integrally formed.

11. The illumination apparatus according to claim 7, wherein the two extending portions are divided.

12. The illumination apparatus according to claim 1, wherein the light source comprises a carrier disposed on the heat dissipation base and a plurality of light emitting diodes disposed on the carrier.
